(19) United States
(12) Patent Application Publication
(10) Pub. No.: US 2016/0103636 A1
(43) Pub. Date: Apr. 14, 2016

(54) INFORMATION PROCESSING DEVICE, TRANSACTION PROCESSING SYSTEM, AND RECORDING DEVICE

(71) Applicant: Seiko Epson Corporation, Tokyo (JP)

(72) Inventors: Shigeo TAJIMA, Matsumoto-shi (JP); Shigeru HIRAI, Aoki-mura (JP)

(73) Assignee: SEIKO EPSON CORPORATION, Tokyo (JP)

(21) Appl. No.: 14/857,220

(22) Filed: Sep. 17, 2015

(30) Foreign Application Priority Data
Oct. 8, 2014 (JP) 2014-207206

(51) Int. Cl. G06F 3/12; G06Q 20/20

(52) U.S. Cl. CPC G06F 3/1206; G06F 3/1251; G06F 3/1267; G06Q 20/209

(57) ABSTRACT

A control server 15 has a control server control unit 40 that receives print data containing transaction information related to a transaction, and executes a process of segmenting the print data according to areas in the image generated based on the print data, and extracting the transaction information based on rules appropriate to each area from the segmented print data, to extract the transaction information from the received print data.

Priority is claimed under 35 U.S.C. §119 to Japanese Application no. 2014-207206 filed on Oct. 8, 2014 which is hereby incorporated by reference in their entirety.

### BACKGROUND

1. Technical Field

The present disclosure relates to an information processing device, a transaction processing system, and a recording device.

2. Related Art

JP-A-2012-27633 describes technology for converting print data output from the transaction processing unit of a POS terminal to a data format that can be interpreted by an external device, and outputting the converted data to the external device. The print data is data for producing a receipt, and contains transaction information related to a sale transaction.

Information processing devices that execute a process of extracting and storing transaction information from data containing transaction information, such as the print data described above, are also known.

When extracting transaction information from print data as in the information processing device described above, there is a need to extract the transaction information appropriately through a process compatible with characteristics or properties of the data.

### SUMMARY

The present disclosure enables processing print data containing transaction information appropriately to characteristics and properties of the data to extract the transaction information.

An information processing device according to the disclosure has a control unit that executes a process of segmenting the print data according to areas in the image generated based on the print data, and extracting the transaction information based on rules appropriate to each area from the segmented print data, to extract the transaction information from received print data containing transaction information related to a transaction.

Thus comprised, transaction information can be extracted from print data containing transaction information by applying a process appropriate to the characteristics of the data.

In an information processing device according to another aspect of the disclosure, the control unit extracts the transaction information by searching for strings in the segmented print data.

Thus comprised, when using a string search to acquire specific information from a print data segment corresponding to one image area, acquiring information by the string search from a print data segment corresponding to a different image area can be prevented, and acquiring wrong information can be prevented.

In an information processing device according to another aspect of the disclosure, the print data is data instructing producing a receipt containing transaction information; and the control unit segments the print data according to the layout of the receipt.

Thus comprised, print data can be segmented based on characteristics of the receipt, and transaction information can be extracted from the segmented print data by an appropriate method based on characteristics of the receipt.

Another aspect of the disclosure is a transaction system including a recording control device and a control server that communicates with the recording control device through a network. The recording control device sends print data to the control server. The control server receives print data containing transaction information related to a transaction, and executes a process of segmenting the print data according to areas in the image generated based on the print data, and extracting the transaction information based on rules appropriate to each area from the segmented print data, to extract the transaction information from the received print data.

Thus comprised, transaction information can be extracted from print data containing transaction information by applying a process appropriate to the characteristics of the data.

In transaction system according to another aspect of the disclosure, the control server stores the extracted transaction information.

Thus comprised, useful information related to transactions can be acquired from the stored transaction information.

In transaction system according to another aspect of the disclosure, the recording control device is a recording device that receives print data from a POS terminal and records based on the print data.

Thus comprised, because the recording device records based on print data received from a POS terminal, print data can be sent from the recording device to the control server, and transaction information can be extracted by the control server processing print data including the transaction information appropriately to the characteristics of the data.

In transaction system according to another aspect of the disclosure, the recording control device is a POS terminal that generates print data, sends the generated print data to a recording device, and causes the recording device to record based on the print data.

Thus comprised, because the POS terminal sends print data to the recording device and controls the recording device to print based on the print data, print data can be sent from the POS terminal to the control server, and the control server can extract transaction information by processing the print data including transaction information appropriately to the characteristics of the data.

Another aspect of the disclosure is a recording device including: a recording unit that prints on a recording medium; a communication unit that receives data to print by the recording unit; and a control unit that controls the communication unit to receive print data containing transaction information related to a transaction, controls the recording unit to print based on the print data received by the communication unit, and extracts the transaction information from the print data received by the communication unit. To extract the transaction information from the print data, the control unit segmenting the print data according to areas in the image generated based on the print data, and extracting the transaction information based on rules appropriate to each area from the segmented print data.

Thus comprised, transaction information can be extracted from print data containing transaction information by applying a process appropriate to the characteristics of the data.

Other objects and attainments together with a fuller understanding of the disclosure will become apparent and appreciated by referring to the following description and claims taken in conjunction with the accompanying drawings.

### BRIEF DESCRIPTION OF THE DRAWINGS

FIG. 1 illustrates the configuration of a transaction processing system according to a preferred embodiment of the disclosure.

FIG. 2 is a block diagram illustrating the functional configuration of devices in the transaction processing system.

FIG. 3 is a flow chart illustrating the operation of devices in the transaction processing system.

FIG. 4 is a flow chart illustrating the operation of a control server.

FIG. 5 shows an example of a receipt.

FIG. 6 shows an example of a receipt and print data.

FIG. 7 shows the data structure of a transaction information management database.

### DESCRIPTION OF EMBODIMENTS

A preferred embodiment of the present disclosure is described below with reference to the accompanying figures.

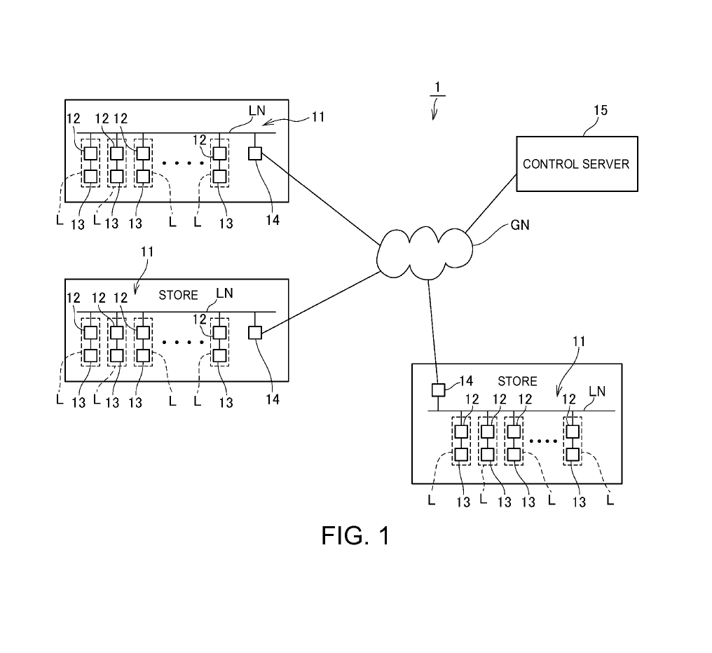

FIG. 1 shows the configuration of a transaction processing system 1 according to a preferred embodiment of the disclosure.

As shown in FIG. 1, the transaction processing system 1 includes a plurality of store systems 11. A store system 11 is a system that is used in retail businesses such as supermarkets, convenience stores, department stores, and restaurants. The store system 11 has functions for processing transactions according to the products purchased by customers, and producing sales (transaction) receipts based on the transactions.

One or more checkout counters L where customer transactions are processed are located in the business. A recording device 12 (recording control device) capable of recording on a recording medium, and a POS terminal 13 that communicates with the recording device 12 and controls the recording device 12, are installed at each checkout counter L.

During a transaction at the checkout counter L, the cash register operator reads the barcode from the product or product packaging using a barcode reader BR connected to the POS terminal 13, and inputs information related to the transaction to the POS terminal 13. Based on input from the barcode reader BR and transaction-related input from the operator, the POS terminal 13 controls the recording device 12 to produce a receipt. The receipt produced by the recording device 12 is then given by the operator to the customer.

The configuration, functions, and processes based on the functions of the recording device 12 and POS terminal 13 are described further below.

A local area network LN is deployed in the store system 11.

The recording device 12 connects to the local area network LN using a communication protocol used on the LAN.

A communication device 14 is also connected to the local area network LN. The communication device 14 is an interface device that connects to the local area network LN and a global network GN (network) such as the Internet. The communication device 14 has the functions of a modem (or ONU (Optical Network Unit)), a router, a DHCP (Dynamic Host Configuration Protocol) server, and a NAT (Network Address Translation) unit. The communication device 14 passes data between devices when a device connected to the local area network LN and a device connected to the global network GN communicate with each other. Note that the communication device 14 is represented by a single function block in FIG. 1, but the communication device 14 may comprise plural devices with different functions.

The recording device 12 can also access the global network GN through the communication device 14.

A control server 15 (information processing device) is connected to the global network GN. The control server 15 is a cloud server in a cloud system in which the recording device 12 is a client. More specifically, when triggered by a request from a client, for example, the control server 15 runs a specific operating process and sends data based on the result of the process to the client. The control server 15 is represented by a single function block in FIG. 1, but this does not mean that the control server 15 is embodied by a single server device. For example, the control server 15 may include a plurality of server devices. More specifically, the control server 15 may be configured in any way enabling executing the processes described below.

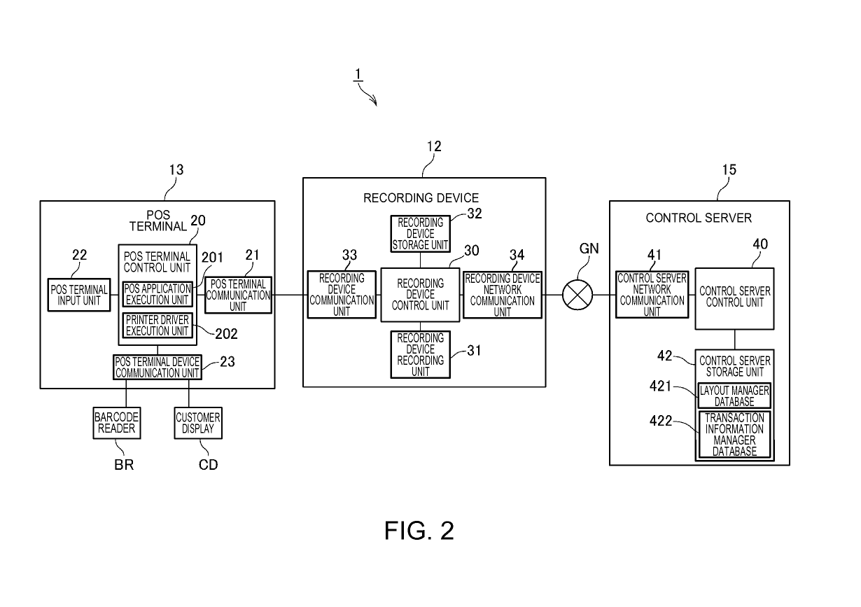

FIG. 2 is a block diagram illustrating the functional configuration of the POS terminal 13, recording device 12, and control server 15.

The POS terminal 13 is a host computer that runs transaction-related processes and controls the recording device 12.

As shown in FIG. 2, the POS terminal 13 includes a POS terminal control unit 20, a POS terminal communication unit 21, a POS terminal input unit 22, and a POS terminal device communication unit 23.

The POS terminal control unit 20 includes a CPU, ROM, RAM, and controls the POS terminal 13. The POS terminal control unit 20 has a POS application execution unit 201 and a printer driver execution unit 202. The function of the POS application execution unit 201 is embodied by the POS terminal control unit 20 reading and running an installed POS application. The function of the printer driver execution unit 202 is embodied by the POS terminal control unit 20 reading and running an installed printer driver. The processes run by these function blocks are described further below.

The POS terminal communication unit 21 communicates with the recording device 12 according to a specific communication protocol as controlled by the POS terminal control unit 20.

The POS terminal input unit 22 has an input means such as a keypad or operating keys, detects input to the input means, and outputs to the POS terminal control unit 20. The POS terminal control unit 20 then executes a process appropriate to the input based on the input from the POS terminal input unit 22.

The POS terminal device communication unit 23 is an interface board with a USB port, a serial communication port other than a USB port, or other types of communication ports. Various devices can connect to the different ports. The POS terminal device communication unit 23 communicates with devices connected to the POS terminal 13 through the appropriate ports as controlled by the POS terminal control unit 20.

Note that the POS terminal device communication unit 23 may also have a wireless communication port for communicating with other devices wirelessly.

A barcode reader BR and customer display CD are examples of devices connected to the POS terminal 13 in this example.

The barcode reader BR is used to read barcodes from products and product packaging, and outputs data representing the read barcodes to the POS terminal device communication unit 23. The POS terminal device communication unit 23 then outputs the data input from the barcode reader BR to the POS terminal control unit 20.

The customer display CD displays transaction-related information as controlled by the POS terminal control unit 20. The information presented on the customer display CD can be read by the customer involved in the transaction at the checkout counter L.

The recording device 12 is a thermal line printer that holds roll paper and forms dots on the stored roll paper with a line thermal head to record images.

As shown in FIG. 2, the recording device 12 has a recording device control unit 30, recording device recording unit 31, recording device storage unit 32, recording device communication unit 33, and recording device network communication unit 34.

The recording device control unit 30 includes a CPU, ROM, RAM, and other peripheral circuits, and controls the recording device 12.

The recording device recording unit 31 includes mechanisms related to recording on roll paper, such as a conveyance mechanism for conveying roll paper stored inside the cabinet of the recording device 12, a recording mechanism for forming dots and recording images on the roll paper with a thermal head, and a cutter mechanism for cutting the roll paper at a specific position. The recording device recording unit 31 records receipt-related images on the roll paper by the recording mechanism while conveying the roll paper with the conveyance mechanism, and then cuts the roll paper at a specific position with the cutter mechanism, producing a receipt.

The recording device storage unit 32 has nonvolatile memory and stores data.

The recording device communication unit 33 communicates with the POS terminal 13 according to a specific communication protocol as controlled by the recording device control unit 30.

The recording device network communication unit 34 communicates with devices connected to the global network GN (including the control server 15) according to a specific communication protocol as controlled by the recording device control unit 30.

The control server 15 is a cloud server to which the recording device 12 connects as a client.

As shown in FIG. 2, the control server 15 includes a control server control unit 40 (control unit), control server network communication unit 41, and control server storage unit 42.

The control server control unit 40 includes a CPU, ROM, RAM, and other peripheral circuits, and controls the control server 15.

The control server network communication unit 41 communicates with devices connected to the global network GN (including recording devices 12) according to a specific communication protocol as controlled by the control server control unit 40.

The control server storage unit 42 includes nonvolatile memory, and stores data. The data stored by the control server storage unit 42 is described further below.

The operation of the POS terminal 13, recording device 12, and control server 15 when processing a transaction at the checkout counter L is described next.

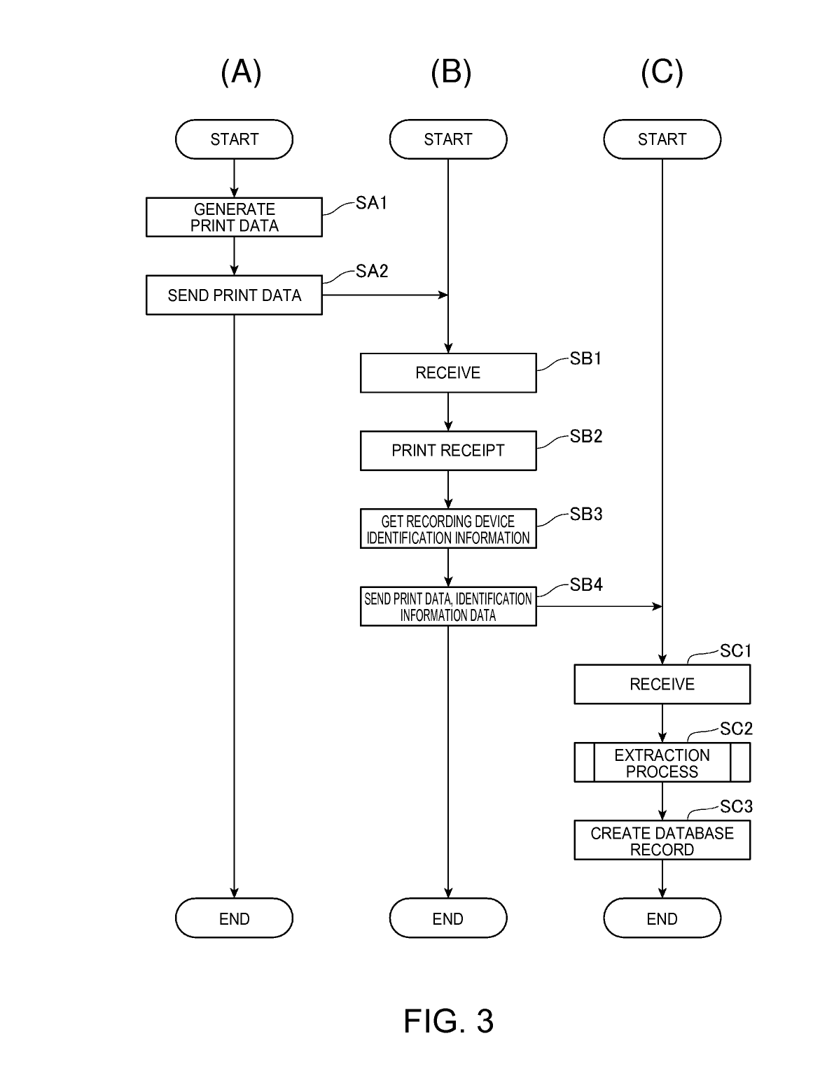

FIG. 3 is a flow chart of the operation of the POS terminal 13, recording device 12, and control server 15, column (A) of FIG. 3 showing the operation of the POS terminal 13, column (B) of FIG. 3 showing the operation of the recording device 12, and column (C) of FIG. 3 showing the operation of the control server 15.

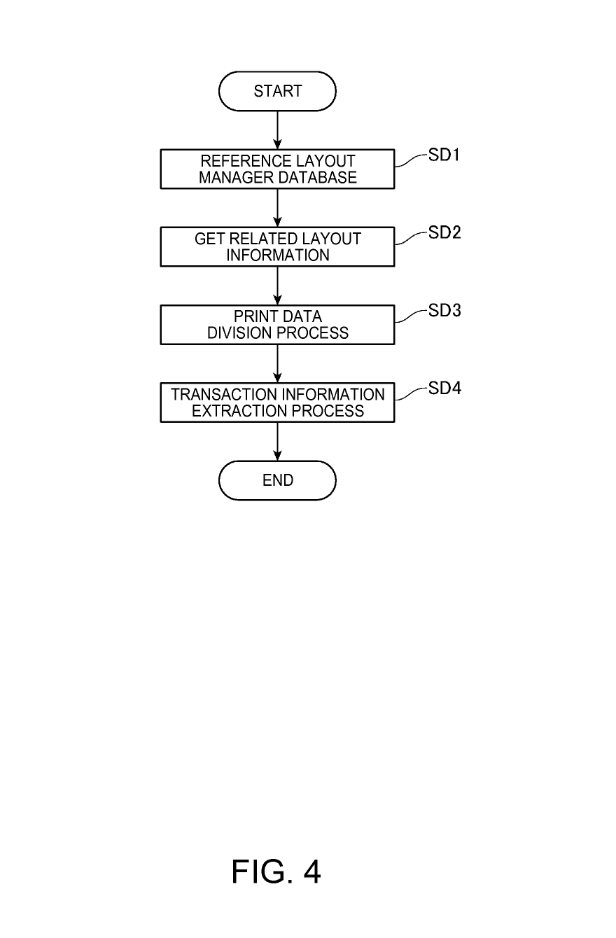

FIG. 4 is a flow chart of the operation of the control server 15 when executing the extraction process described further below.

As shown in column (A) of FIG. 3, the POS terminal control unit 20 of the POS terminal 13 executes a payment process according to the customer transaction, and generates print data based on the payment process (step SA1). The print data is control data instructing producing a receipt.

More specifically, in step SA1, the POS application execution unit 201 of the POS terminal control unit 20 generates receipt information based on the customer transaction. The receipt information is information the recording device 12 records on the produced receipt.

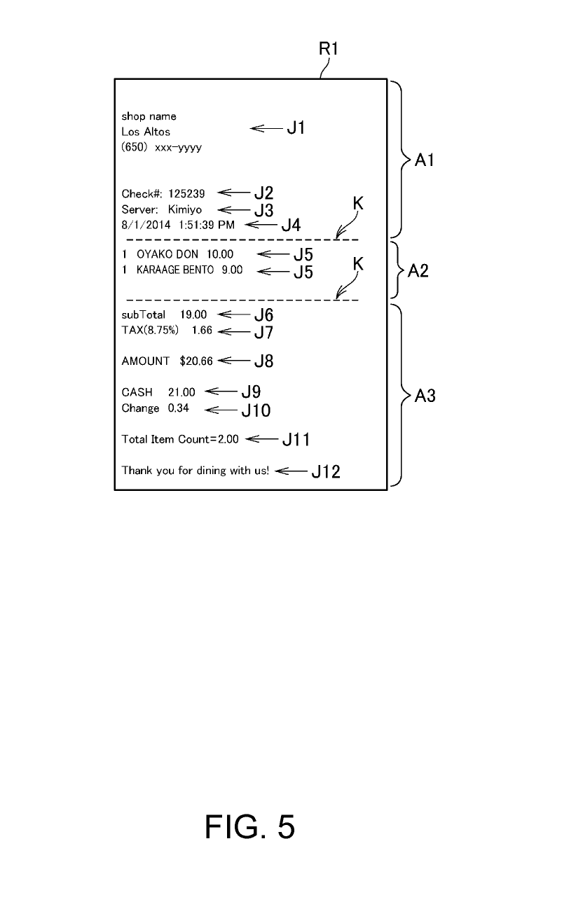

An example of a receipt is shown in FIG. 5 and the receipt information is described below.

FIG. 5 shows receipt R1 as an example of a receipt.

As shown in FIG. 5, the receipt R1 has a receipt header area A1, a line item area A2, and a receipt footer area A3 that are separated by delimiter information K, which in this example are recorded as a line of hyphens (-) widthwise.

Below, the receipt header area A1 is also referred to as area A1, the line item area A2 as area A2, and the receipt footer area A3 as area A3.

Store-related information J1 (also referred to below as needed as information J1) including the name of the store that issues the receipt and the telephone number of the store is recorded in the receipt header area A1.

Also recorded in the receipt header area A1 is receipt identification information J2 (also referred to below as needed as information J2) including a receipt ID that identifies a specific receipt.

Also recorded in the receipt header area A1 is register operator identification information J3 (also referred to below as needed as information J3) including information such as the name of the operator of the register at the checkout counter L where the transaction is completed. The register operator identification information J3 is registered by a specific means in the POS terminal 13 at a specific time before the transaction starts.

Also recorded in the receipt header area A1 is receipt date information J4 (also referred to below as needed as information J4) including information indicating when the receipt is produced.

One or more lines of line item information J5 (also referred to below as needed as information J5) is recorded in the line item area A2 according to the products the customer purchases.

The line item information J5 is a single line of information, and in this example includes purchase quantity information J51 including information indicating the quantity (number) of the product on that line, product name information J52 including information indicating the name of the product, and unit price information J53 including information indicating the unit price of the product.

In the example shown in FIG. 5, a two-character space is between the purchase quantity information J51 and the product name information J52, and a two-character space is between the product name information J52 and the unit price information J53.

Note that when the product name information includes more than one word, there is a one-character space between each word.

Subtotal information J6 (also referred to below as needed as information J6) including information indicating the subtotal is recorded in the receipt footer area A3.

Also recorded in the receipt footer area A3 is tax-related information J7 (also referred to below as needed as information J7) including information about the applicable taxes.

Also recorded in the receipt footer area A3 is transaction total information J8 (also referred to below as needed as information J8) including information indicating the transaction total.

Also recorded in the receipt footer area A3 is cash-related information J9 (also referred to below as needed as information J9) including information indicating the amount of money received from the customer.

Also recorded in the receipt footer area A3 is change-related information J10 (also referred to below as needed as information J10) including information indicating the amount of change due to the customer.

Also recorded in the receipt footer area A3 is total item count information J11 (also referred to below as needed as information J11) including information indicating the total number of items purchased by the customer.

Also recorded in the receipt footer area A3 is message information J12 (also referred to below as needed as information J12) containing a specific message for the customer.

The receipt information in this sample receipt R1 includes information J1 to J12 and the two delimiter information K objects.

Unless changed by the user, a single POS terminal 13 produces receipts with images recorded according to the same layout from the one recording device 12 connected to that POS terminal 13. For example, the POS terminal 13 controlling the recording device 12 that produced the receipt R1 shown in FIG. 5 produces a receipt recording an image conforming to the layout shown in the receipt R1 whenever the recording device 12 produces a receipt.

The layout shown in receipt R1 is divided into three sections (areas) by the delimiter information K, information J1 to information J4 are recorded in a specific order in a specific format in the receipt header area A1; one or more line items J5 are recorded in the line item area A2 in a specific format; and information J6 to information J12 are recorded in a specific order in a specific format in the receipt footer area A3.

The layout of the receipts may also differ according to the recording device 12 that produces a particular receipt. For example, the layout of receipts produced by recording devices 12 may differ according to differences in the stores where the recording devices 12 are used, and the layout of receipts produced by recording devices in the same store may differ according to the department where a particular recording device 12 is used.

In step SA1, the POS application execution unit 201 generates receipt information and outputs the generated receipt information to the printer driver execution unit 202.

The printer driver execution unit 202 generates print data based on the receipt information input from the POS application execution unit 201. The print data is control data instructing recording the receipt information according to the corresponding layout, and includes plural control commands in the command language of the recording device 12.

After the print data is generated, the POS terminal control unit 20 controls the POS terminal communication unit 21 to send the generated print data to the recording device 12 (step SA2).

As shown in column (B) of FIG. 3, the recording device control unit 30 of the recording device 12 controls the recording device communication unit 33 to receive the print data (step SB1).

Next, the recording device control unit 30 controls the recording device recording unit 31 based on the received print data to produce a receipt (step SB2).

Next, the recording device control unit 30 gets the recording device identification information (step SB3). The recording device identification information is identification information identifying the recording device 12, and different recording device identification information is assigned to each recording device 12. For example, the recording device identification information may be the serial number assigned to the recording device 12 when the recording device 12 is manufactured. The recording device identification information is stored in a specific storage area of the recording device storage unit 32, and in step SB3 the recording device control unit 30 reads the recording device identification information from the specific storage area.

Next, the recording device control unit 30 controls the recording device network communication unit 34 to send the print data and identification information data representing the recording device identification information to the control server 15 (step SB4).

As shown in column (C) of FIG. 3, the control server control unit 40 of the control server 15 controls the control server network communication unit 41 to receive the print data and identification information data (step SC1).

Next, the control server control unit 40 executes the extraction process based on the received print data and identification information data (step SC2).

The extraction process of step SC2 is described next.

FIG. 4 is a flow chart illustrating the operation of the control server 15 when running the extraction process.

As shown in FIG. 4, the control server control unit 40 of the control server 15 references a layout manager database 421 stored in the control server storage unit 42 (step SD1).

The layout manager database 421 is a database relationally storing the recording device identification information of the recording device 12 and layout information related to the layout of receipts printed by that recording device 12 for each recording device 12 that can access the control server 15 as a client.

The layout information is described below.

A receipt is characteristically divided into multiple areas and specific receipt information is recorded in each area. As described above, the receipt R1 shown in FIG. 5 is divided into area A1 to area A3, information J1 to information J4 is recorded in area A1, one or more lines of line item information J5 are recorded in area A2, and information J6 to information J12 are recorded in area A3.

The layout information similarly includes related area information Q1 identifying each of the areas in the receipt; recorded receipt information Q2 indicating what type of receipt information is recorded in what format in each receipt area; and area delimiter information Q3 identifying how the areas are separated (delimited).

When referring to the layout of the receipt R1 shown for example in FIG. 5, the related area information Q1 is information indicating that the area of the receipt is divided into three areas, area A1, area A2, and area A3.

When referring to the layout of the receipt R1 shown for example in FIG. 5, the recorded receipt information Q2 includes the following information for area A1. More specifically, the recorded receipt information Q2 includes information indicating that information J1 to information J4 are recorded, and the format for recording the information in the area A1.

In this example, the recorded receipt information Q2 includes information indicating that information J1 is recorded at the beginning of the area A1. The recorded receipt information Q2 also includes information indicating that in information J1 the string “shop_name” (where here and below the underscore “_” represents a one-character white space) representing the name of the store is recorded left-aligned on line 1, a string indicating the name of the store is recorded left-aligned on line 2, and a string indicating the telephone number of the store is recorded left-aligned on line 3.

The recorded receipt information Q2 also includes information indicating that information J2 is recorded three lines below information J1 in the area A1. The recorded receipt information Q2 also includes information indicating that the string “Check #:” is recorded left-aligned in information J2 followed by a space and then the receipt ID.

The recorded receipt information Q2 also includes information indicating that in area A1 information J3 is recorded on the next line after information J2. The recorded receipt information Q2 also includes information indicating that in information J3 the string “Server:” is recorded left-aligned followed by a character space and then a string indicating the name of the cash register operator (checkout clerk).

The recorded receipt information Q2 also includes information indicating that information J4 is recorded on the next line after information J3 in area A1.

In the layout of the receipt R1 shown for example in FIG. 5, the recorded receipt information Q2 also includes information indicating that the following information is recorded in area A2.

More specifically, the recorded receipt information Q2 also includes information indicating that one or more line item information J5 blocks are recorded in area A2. The recorded receipt information Q2 also includes information indicating that the line item information J5 is a single line of information, and includes information indicating that purchase quantity information J51 is recorded left-aligned and is followed by a two-character space followed by product name information J52, a two-character space, and then the unit price information J53.

In the layout of the receipt R1 shown for example in FIG. 5, the recorded receipt information Q2 also includes information indicating that the following information is recorded in area A3. More specifically, the recorded receipt information Q2 includes information indicating information J6 to information J12 are recorded, and the format for recording the information in the area A3.

In this example, the recorded receipt information Q2 includes information indicating that information J6 is recorded at the beginning of the area A3. The recorded receipt information Q2 also includes information indicating that in information J6 the string “Subtotal” is recorded left-aligned, followed by a two-character space, and then a string representing the transaction subtotal.

The recorded receipt information Q2 also includes information indicating that in area A3 information J7 is recorded on the next line after information J6. The recorded receipt information Q2 also includes information indicating that in information J7 the string “TAX (* %)” (where the asterisk (*) indicates a string denoting the tax rate) is recorded left-aligned, followed by a two-character space, and ending with a string denoting the amount of tax.

The recorded receipt information Q2 also includes information indicating that in area A3 information J8 is recorded two lines below information J7. The recorded receipt information Q2 also includes information indicating that in information J8 the string “AMOUNT” is recorded left-aligned, followed by a two-character space, and ending with a string denoting the total amount of the transaction.

The recorded receipt information Q2 also includes information indicating that in area A3 information J9 is recorded two lines below information J8. The recorded receipt information Q2 also includes information indicating that in information J9 the string “CASH” is recorded left-aligned, followed by a two-character space, followed by a string denoting the amount received from the customer.

The recorded receipt information Q2 also includes information indicating that in area A3 information J10 is recorded on the next line after information J9. The recorded receipt information Q2 also includes information indicating that in information J10 the string “Change” is recorded left-aligned, followed by a two-character space, followed by the amount of change returned to the customer.

The recorded receipt information Q2 also includes information indicating that in area A3 information J11 is recorded two lines below the information J10. The recorded receipt information Q2 also includes information indicating that in information J11 the string “Total_Item_Count=” is recorded left-aligned followed by a string denoting the total number of items purchased with no space therebetween.

The recorded receipt information Q2 also includes information indicating that information J12 is recorded two lines below information J11.

In the layout of the receipt R1 shown for example in FIG. 5, the area delimiter information Q3 is includes information indicating that the receipt areas are separated by the delimiter information K.

As shown in FIG. 4, after referencing the layout manager database 421 in step SD1, the control server control unit 40 retrieves the layout information relationally stored to the recording device identification information in the database by using the recording device identification information identified by the received identification information data as the search key (step SD2).

Next, the control server control unit 40 executes a print data division process (step SD3).

The print data division process of step SD3 is described next.

The print data is described first before describing the print data division process.

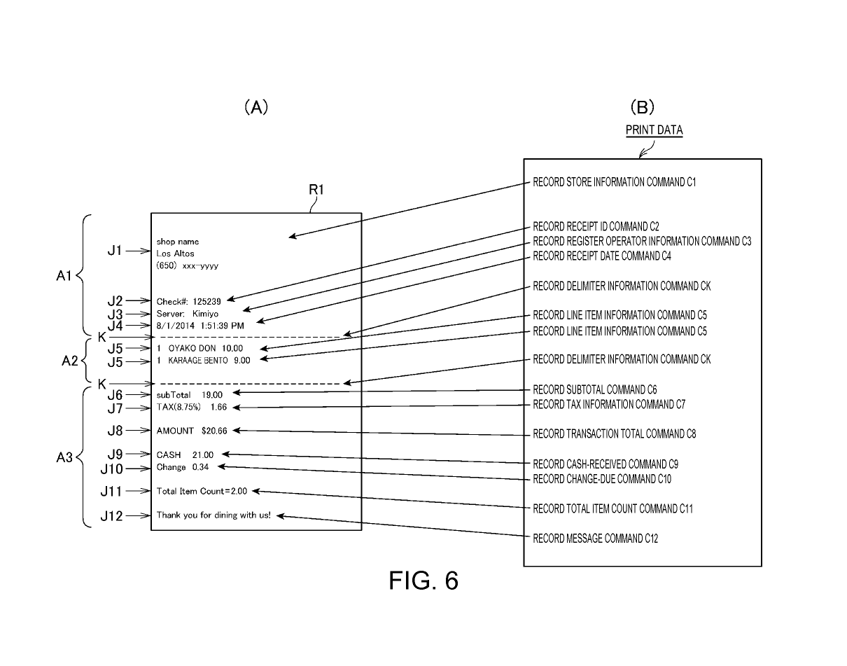

The left side (A) of FIG. 6 shows the receipt R1 shown in FIG. 5, and the right side (B) of FIG. 6 shows the print data for issuing the receipt R1.

Note that the print data is simplified for brevity in the right side (B) of FIG. 6.

The print data is a group of control commands specific to the receipt information to be recorded on a particular receipt.

In the example in the right side (B) of FIG. 6, the first control command in the print data is a record store information command C1 (also referred to below as control command C1) instructing recording information J1.

The record store information command C1 includes a control command containing a specific command code instructing recording a string and the string (a combination of specific character codes) to record, a control command instructing any specific styles to apply when recording the string, and a control command instructing a carriage return. Other control commands instructing recording receipt information likewise contain these control commands. Styles as used here mean some process related to drawing the string to be recorded. Examples of styles include moving the position of the string (left-aligned, centered, right aligned, for example), enlarging, reducing, or rotating the string, and adding effects such as emphasis, bold, or special characters or symbols.

Following the record store information command C1, the print data also sequentially includes a record receipt ID command C2 (also referred to below as control command C2), a record register operator information command C3 (also referred to below as control command C3), and a record receipt date command C4 (also referred to below as control command C4), for recording information J2, J3, and J4.

The next control command after the record receipt date command C4 in the print data is a record delimiter information command CK instructing recording the first delimiter K. As described above, area Al and area A2 are separated in the receipt R1 by one delimiter K. As a result, the control commands C1 to C4 preceding the first record delimiter information command CK in the print data are the control commands instructing recording receipt information to area A1.

Following the first record delimiter information command CK, the print data in this example has two record line item information commands C5 (also referred to below as control command C5) instructing recording information J5.

The next command after the second (last) record line item information command C5 in the print data is a record delimiter information command CK instructing recording the second delimiter K. As described above, area A2 and area A3 are separated in the receipt R1 by one delimiter K. As a result, the one or more record line item information commands C5 between the first record delimiter information command CK and the second record delimiter information command CK in the print data are the control commands instructing recording receipt information to area A2.

Sequentially following the second record delimiter information command CK in the print data are a record subtotal command C6 instructing recording information J6; a record tax information command C7 (also referred to below as control command C7) instructing recording information J7; a record transaction total command C8 (also referred to below as control command C8) instructing recording information J8; a record cash-received command C9 (also referred to below as control command C9) instructing recording information J9; a record change-due command C10 (also referred to below as control command C10) instructing recording information J10; a record total item count command C11 (also referred to below as control command C11) instructing recording information J11; and a record message command C12 (also referred to below as control command C12) instructing recording information J12.

As described above, area A2 and area A3 in the receipt R1 are separated by the second delimiter information K. As a result, the control commands C6 to C12 following the second record delimiter information command CK in the print data are the control commands instructing recording receipt information to area A3.

When sending print data, the POS terminal 13 sequentially sends the control commands in the following order: control commands C1 to C4, the first record delimiter information command CK, two control commands C5, the second record delimiter information command CK, and control command C6 to control command C12. When receiving print data, the recording device 12 stores the control commands in the receive buffer in the order transmitted from the POS terminal 13, and processes the commands sequentially.

In the print data division process of step SD3, the control server control unit 40 divides the plural control commands contained in the print data into groups of commands according to the areas of the receipt based on the layout information acquired in step SD2.

The process of grouping the control commands in the print data is an example of a process that segments the print data according to the areas in the recorded image.

Dividing (grouping) the print data does not mean storing the segmented print data resulting from the grouping process to separate storage areas. The print data may be stored continuously to a single storage area. More specifically, the data may be stored in any way enabling the control server control unit 40 to know the group corresponding to the area where the data contained in the print data belongs.

For example, if the receipt produced from the print data is the receipt R1 shown in FIG. 6, the area delimiter information Q3 of the layout information acquired by the control server control unit 40 in step SD2 is information indicating that the receipt areas are separated by the delimiter information K. Note that the delimiter information K in this example is an image formed by recording a series of hyphens (-) across the width of the receipt. The related area information Q1 is information indicating that the receipt R1 is divided into three areas, area A1, area A2, and area A3.

Based on the above, the control server control unit 40 first analyzes the print data and extracts the two record delimiter information commands CK from the control commands in the print data. Because a record delimiter information command CK instructs recording a series of hyphens as the string to record, the record delimiter information commands CK can be extracted by searching for a string of plural consecutive hyphens.

Next, the control server control unit 40 groups the control commands (control commands C1 to C4 in this example) before the first record delimiter information command CK as the command group (below, the first group) corresponding to area A1. The control server control unit 40 also groups the control commands (the two control commands C5 in this example) between the first record delimiter information command CK and the second record delimiter information command CK as the command group (below, the second group) corresponding to area A2. The control server control unit 40 also groups the control commands (control commands C6 to C12 in this example) after the second record delimiter information command CK as the command group (below, the third group) corresponding to area A3.

This completes the print data division process of step SD3.

Referring again to FIG. 4, after the print data division process of step SD3, the control server control unit 40 executes the transaction information extraction process (step SD4).

The transaction information extraction process of step SD4 is described next.

The transaction information extraction process is a process for extracting predetermined information (referred to in this example as transaction information) from the receipt information recorded on a receipt.

The control server control unit 40 extracts the transaction information based on rules corresponding to specific areas from the groups of control commands corresponding to the areas in the receipt (from the print data after grouping the control commands into groups).

Using the layout of the receipt R1 shown in FIG. 5 for example, the control server control unit 40 extracts the transaction information as described below.

Based on information related to the information J1 contained in the recorded receipt information Q2 of the layout information acquired in step SD2, the control server control unit 40 acquires information denoting the name of the store (store name information) and information denoting the telephone number of the store (telephone number information) from the control commands belonging to the first group.

More specifically, based on the information related to information J1, the control server control unit 40 recognizes that a string denoting the store name is recorded one line after the string shop_name, and a string denoting the telephone number of the store is recorded one line after the store name string.

Next, the control server control unit 40 does a string search using the string shop_name as the search key to extract the control command instructing recording the string shop_name from the control commands in the first group.

Next, the control server control unit 40 extracts the control command instructing recording a string one line after the control command instructing recording the string shop_name as the control command for recording the string of the store name.

Next, the control server control unit 40 extracts the string of the store name from the control command for recording the store name string, and gets the store name information.

Next, the control server control unit 40 extracts the control command instructing recording a string one line after the control command instructing recording the store name string as the control command for recording the string denoting the telephone number of the store.

Next, the control server control unit 40 gets the telephone number information by extracting the string of the telephone number of the store from the control command for recording the string of the telephone number of the store.

The control server control unit 40 thus acquires the store name information and the telephone number information as transaction information from the information J1. The control server control unit 40 performs string searches using specific strings (such as the string shop_name in this example) as the search key, and acquires the above information using the results of the string searches.

Note that there could be a product containing the string shop_name in the product name, the string shop_name may be recorded in area A2. Therefore, if the control server control unit 40 searches all control commands contained in the print data to find a control command using the string shop_name as the search key, a control command for recording in area A1 and a control command for recording in area A2 could be found. If the control command instructing recording in area A2 is found, the control server control unit 40 may acquire wrong information as the store name information and the telephone number information.

Therefore, to acquire the store name information and telephone number information when the control commands contained in the print data are grouped according to area A1 to area A3, the control server control unit 40 uses the string shop_name as the search key to search only in area A1 for control commands instructing recording the strings corresponding to the desired information. This prevents acquiring wrong information.

To acquire the information denoting the receipt ID (receipt ID information), the control server control unit 40 searches the control commands in the first group using the string Check #: as the search key based on information related to information J2 contained in the recorded receipt information Q2 of the layout information, and acquires the desired information using the result of the string search.

To acquire the information identifying the cash register operator (operator information), the control server control unit 40 searches the control commands in the first group using the string Server: as the search key based on information related to information J3 contained in the recorded receipt information Q2 of the layout information, and acquires the desired information using the result of the string search.

To acquire the information identifying the date of the receipt (receipt date information), the control server control unit 40 acquires the desired information knowing that information J4 is recorded one line after information J3, for example, based on information related to information J4 contained in the recorded receipt information Q2 of the layout information.

Using rules that are different from those applied to the control commands belonging to the first group, the control server control unit 40 also extracts transaction information from the control commands belonging to the second group.

More specifically, the control server control unit 40 recognizes the following based on information related to the information J5 contained in the recorded receipt information Q2 of the layout information acquired in step SD2. The control server control unit 40 knows that one or more line item information J5 blocks are contained in area A2. The control server control unit 40 also knows that the line item information J5 is one line of information, the purchase quantity information J51 is recorded left-aligned, the product name information J52 is recorded after a two-character space, and the unit price information J53 is then recorded after another two-character space.

Based on knowing this format, the control server control unit 40 sequentially processes the control commands C5 in the second group, and extracts the information denoting the quantity of the purchased time (product quantity information), information denoting the product name (product name information), and information denoting the unit price of the product (unit price information) from the control command C5 being processed by the method described below. As a result, the control server control unit 40 acquires the quantity, name, and price of each product purchased by the customer.

The control server control unit 40 acquires the above information by extracting strings from the control command C5 being processed. The extracted strings are formatted with a string denoting the purchased quantity, a two-character space, a string denoting the product name, a two-character space, and a string denoting the unit price. The control server control unit 40 uses the structure of the acquired string to extract the string denoting the quantity to get the purchased quantity information, extract the string denoting the product name and get the product name information, and extract the string denoting the unit price to get the price information.

The control server control unit 40 also extracts transaction information from the control commands belonging to the third group using rules that are different from those applied to the control commands belonging to the first group and second group.

More specifically, the control server control unit 40 recognizes the information J6 to J12 recorded in area A3, and recognizes the format used to record the information J6 to information J12, based on the layout information acquired in step SD2. Based thereon, the control server control unit 40 appropriately searches the control commands belonging to the third group using the corresponding strings as the search keys to acquire the transaction information.

As a result, the control server control unit 40 acquires the information (subtotal information) denoting the subtotal corresponding to subtotal information J6; the information (tax information) denoting the tax amount corresponding to tax information J7; the information (transaction total information) denoting the total amount of the transaction corresponding to the transaction total information J8; the information (cash received information) denoting the amount of money received corresponding to the cash-related information J9; the information (change due information) denoting the amount of change due to the customer corresponding to the change-related information J10; and the information (total item count information) denoting the total number of items purchased corresponding to the total item count information J11.

To acquire the transaction total information, for example, the control server control unit 40 searches the control commands using the string AMOUNT as the search key, and acquires the desired information using the result of the string search. Because the string AMOUNT could be contained in the name of the store or a product name, the control server control unit 40 limits the string search to control commands belonging to the third group associated with area A3 during the string search using the string AMOUNT as the search key. Searching the wrong commands can therefore be prevented, and acquiring the wrong information as the transaction total information can be prevented.

This completes the transaction information extraction process of step SD4.

Using the example of the layout of a receipt R1 described above, the control server control unit 40 in this embodiment acquires as the transaction information: store name information, telephone number information, receipt ID information, cash register operator (checkout clerk) information, receipt date information, purchased quantity information, product name information, unit price information, subtotal information, tax information, transaction total information, cash-received information, change-due information, and total item count information. The combined information is an example of transaction information.

As shown in column (C) of FIG. 3, after the extraction process of step SC2, the recording device control unit 30 accesses the transaction information manager database 422 stored by the control server storage unit 42 and creates a record based on the print data in the database (step SC3).

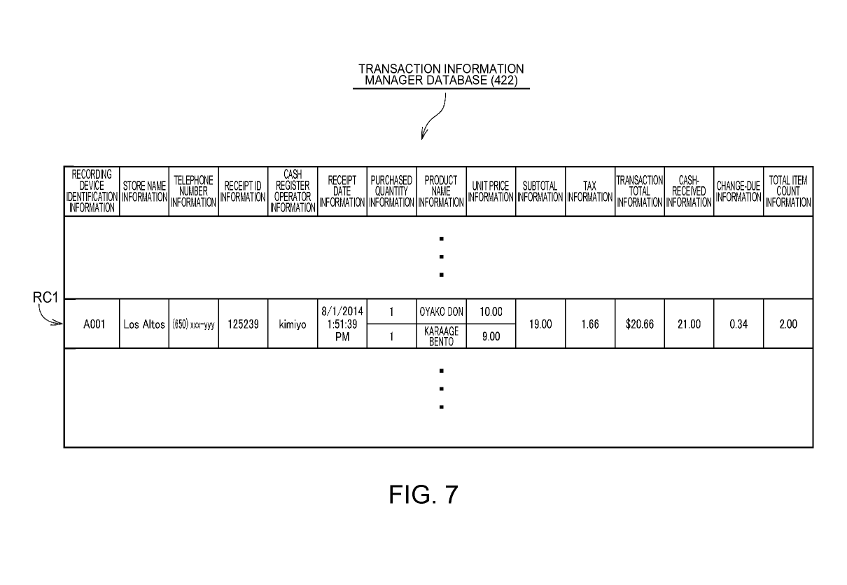

FIG. 7 illustrates the data structure of the transaction information management database 422.

As shown in FIG. 7, one record in the transaction information manager database 422 contains recording device identification information, store name information, telephone number information, receipt ID information, cash register operator (checkout clerk) information, receipt date information, purchased quantity information, product name information, unit price information, subtotal information, tax information, transaction total information, cash-received information, change-due information, and total item count information.

In step SC3, the control server control unit 40 creates one record in the transaction information manager database 422, and stores the recording device identification information denoted by the identification information data received in step SC1 in the corresponding field of the created record. The control server control unit 40 also stores the transaction information extracted in the transaction information extraction process described above in the corresponding fields of the created record.

Note that record RC1 in FIG. 7 shows an example of the record created based on the print data used to print the receipt R1 in FIG. 5.

As described above, each time print data is received, transaction information is extracted from the print data, and a record related to the transaction information is stored in the transaction information manager database 422 based on the extracted transaction information. Records storing transaction information for each transaction completed at each checkout counter L in each store are thus stored cumulatively in the transaction information manager database 422 based on the individual transactions. As a result, sales per store during a specific period of time, sales per product, sales per checkout counter L, and other useful transaction related information can be extracted from the transaction information manager database 422.

As described above, a transaction system 1 according to this embodiment includes a recording device 12 (recording control device), and a control server 15 that communicates with the recording device 12 through a global network GN (network). The recording device 12 sends print data to the control server 15.

The control server 15 has a control server control unit 40 (control unit) that receives print data containing transaction information related to a transaction, segments the print data according to areas in the image recorded based on the print data, and extracts transaction information based on rules appropriate to each area from the segmented print data to extract the transaction information from the received print data.

Thus comprised, because print data is segmented according to areas in the image based on the print data, and transaction information can be extracted based on rules appropriate to the areas from the segmented print data of each area, transaction information can be appropriately extracted from the segmented print data of each area based on rules related to the format used to record information in each area.

Note that the control server 15 is an example of an information processing device according to the disclosure.

The control server control unit 40 of the control server 15 in the embodiment described above extracts transaction information by applying string searches to the segmented print data (control commands grouped appropriately to the image areas).

Thus comprised, when acquiring specific information by a string search from the print data segment corresponding to one of the areas in the layout, acquiring information based on the string search from a print data segment corresponding to an area other than target area (the area being processed) can be prevented, and acquiring wrong information can be prevented.

The print data in the foregoing embodiment is data instructing printing a receipt with transaction information, and the control server control unit 40 segments the print data appropriately to the layout of the receipt.

Thus comprised, print data can be segmented appropriately to characteristics of the receipt, and transaction information can be extracted by a method appropriate to the characteristics of the receipt from the print data segments.

The control server 15 in the foregoing embodiment also stores the extracted transaction information.

Thus comprised, useful information related to transactions can be acquired from the transaction information stored by the control server 15.

### EXAMPLE 1

An example of a first variation of the foregoing embodiment is described below.

The device that sends print data to the control server 15 in the foregoing embodiment is the recording device 12. Alternatively, the POS terminal 13 and control server 15 may be communicatively connected through the global network GN, and the POS terminal 13 may send print data to the control server 15. In this event, the POS terminal 13 is example of a recording control device according to the disclosure.

This configuration has the same effect as the embodiment described above.

### EXAMPLE 2

An example of a second variation of the foregoing embodiment is described below.

In the embodiment described above, the recording device 12 sends print data to the control server 15, and the control server 15 runs the extraction process on the print data according to the flow chart shown in FIG. 4 to extract transaction information from the print data.

Alternatively, the recording device 12 may apply the extraction process described using the flow chart in FIG. 4 to the print data received from the POS terminal 13 to extract the transaction information from the print data. More specifically, the recording device 12 applies the extraction process described using the flow chart in FIG. 4 to the print data received from the POS terminal 13 and extracts the transaction information from the print data. The recording device 12 sends the extracted transaction information with the recording device identification information of the recording device 12 to the control server 15. The control server 15 then stores the recording device identification information received from the recording device 12 relationally to the transaction information. In this example, the recording device control unit 30 is a control unit, and the recording device recording unit 31 is a recording unit. The recording device 12 is also example of an information processing device.

This configuration has the same effect as the embodiment described above.

The disclosure is described above with reference to a preferred embodiment thereof, but the disclosure is not limited thereto and can be modified and adapted in many ways without departing from the scope of the accompanying claims.

The foregoing embodiment describes receipt R1 as an example of a receipt, and applies an extraction process corresponding to the layout of the receipt R1. The receipt layout is not limited to this example, however, and the transaction information extracted from the receipt is not limited to the information described above. For example, if identification information for the customer that completed a transaction is recorded in a specific format at a specific location on the receipt, the customer identification information may also be extracted as part of the transaction information in the extraction process described above.

The transaction information stored in the transaction information manager database 422 is also not limited to the information described above.

The disclosure being thus described, it will be obvious that it may be varied in many ways. Such variations are not to be regarded as a departure from the spirit and scope of the disclosure, and all such modifications as would be obvious to one skilled in the art are intended to be included within the scope of the following claims.

What is claimed is:

1. An information processing device comprising:
a control unit that executes a process of segmenting the print data according to areas in the image generated based on the print data, and extracting the transaction information based on rules appropriate to each area from the segmented print data, to extract the transaction information from received print data containing transaction information related to a transaction.

2. The information processing device described in claim 1, wherein:
the control unit extracts the transaction information by searching for strings in the segmented print data.

3. The information processing device described in claim 1, wherein:
the print data is data instructing producing a receipt containing transaction information; and
the control unit segments the print data according to the layout of the receipt.

4. A transaction system comprising:
a recording control device; and
a control server that communicates with the recording control device through a network;
the recording control device sending print data to the control server; and
the control server receiving print data containing transaction information related to a transaction, and
executing a process of segmenting the print data according to areas in the image generated based on the print data, and extracting the transaction information based on rules appropriate to each area from the segmented print data, to extract the transaction information from the received print data.

5. The transaction system described in claim 4, wherein:
the control server stores the extracted transaction information.

6. The transaction system described in claim 4, wherein:
the recording control device is a recording device that receives print data from a POS terminal and records based on the print data.

7. The transaction system described in claim 4, wherein:
the recording control device is a POS terminal that generates print data, sends the generated print data to a recording device, and causes the recording device to record based on the print data.

8. The transaction system described in claim 4, wherein:
the control server extracts the transaction information by searching for strings in the segmented print data.

9. The transaction system described in claim 4, wherein:
the print data is data instructing producing a receipt containing transaction information; and
the control server segments the print data according to the layout of the receipt.

10. A recording device comprising:
a recording unit that prints on a recording medium;
a communication unit that receives data to print by the recording unit; and
a control unit that controls the communication unit to receive print data containing transaction information related to a transaction, controls the recording unit to print based on the print data received by the communication unit, and extracts the transaction information from the print data received by the communication unit,
the control unit segmenting the print data according to areas in the image generated based on the print data, and extracting the transaction information based on rules appropriate to each area from the segmented print data, to extract the transaction information from the print data.

11. The recording device described in claim 10, wherein:
the control unit extracts the transaction information by searching for strings in the segmented print data.

12. The recording device described in claim 10, wherein:
the print data is data instructing producing a receipt containing transaction information; and
the control unit segments the print data according to the layout of the receipt.
